(19) United States
(12) Patent Application Publication
(10) Pub. No.: US 2026/0211151 A1
(43) Pub. Date: Jul. 23, 2026

(54) TEMPERATURE-STRAIN DETECTION SYSTEM AND METHOD FOR RESERVOIR ROCK MASS

(71) Applicant: Institute of Geology and Geophysics, CAS, Beijing (CN)

(72) Inventors: Bowen ZHENG, Beijing (CN); Shengwen QI, Beijing (CN); Wenjie HAO, Beijing (CN); Wang ZHANG, Beijing (CN); Bo WAN, Beijing (CN); Wei LU, Beijing (CN); Xiaokun HOU, Beijing (CN); Guangming LUO, Beijing (CN); Lina MA, Beijing (CN); Zan WANG, Beijing (CN); Weiwei ZHU, Beijing (CN); Songfeng GUO, Beijing (CN); Yu ZOU, Beijing (CN); Guoliang LI, Beijing (CN); Tianming HUANG, Beijing (CN); Yanlong KONG, Beijing (CN); Yuran ZHANG, Beijing (CN); Chao JIN, Beijing (CN); Ning LIANG, Beijing (CN); Yongchao LI, Beijing (CN)

(21) Appl. No.: 19/450,048

(22) Filed: Jan. 15, 2026

(30) Foreign Application Priority Data
Jan. 22, 2025 (CN) 202510095868.2

(51) Int. Cl. G01V 8/24; G01D 5/353; G01K 11/3206; G01L 1/24

(52) U.S. Cl. CPC G01V 8/24; G01D 5/35316; G01K 11/3206; G01L 1/246

(57) ABSTRACT

A temperature-strain detection system and method for reservoir rock mass are disclosed by the present disclosure, which relate to the field of rock engineering geomechanics testing and measurement. The temperature-strain detection system and method for reservoir rock mass includes a light source, a strain measurement module, a temperature measurement module, a sensing optical fiber, and a processing module. The light source is respectively connected to the strain measurement module and the temperature measurement module; the strain measurement module and the temperature measurement module are both connected to the processing module; the strain measurement module and the temperature measurement module are both connected to the sensing optical fiber; the sensing optical fiber is arranged in the reservoir rock mass; the sensing optical fiber is engraved with an uwFBG array.

### CROSS-REFERENCE TO RELATED APPLICATION

This patent application claims the benefit and priority of Chinese Patent Application No. 202510095868.2, entitled “TEMPERATURE-STRAIN DETECTION SYSTEM AND METHOD FOR RESERVOIR ROCK MASS” filed with the China National Intellectual Property Administration on Jan. 22, 2025, the disclosure of which is incorporated by reference herein in its entirety as part of the present application.

### TECHNICAL FIELD

The present disclosure relates to the field of rock engineering geomechanics testing and measurement, in particular to a temperature-strain detection system and method for reservoir rock mass under true triaxial high temperature loading conditions.

### BACKGROUND

If the supercritical carbon dioxide is injected into the deep geological body, complex physical, chemical and mechanical responses will occur under the action of multi-phase field coupling. In the process of deep oil and gas production enhanced by the supercritical carbon dioxide and deep geothermal development enhanced by the carbon dioxide, the dissolution of the supercritical carbon dioxide in reservoir fluids has acid corrosiveness, which has short term effects and long term effects on the porosity, the permeability and the mechanical properties of the rock mass. If the supercritical carbon dioxide with relatively low temperature contacts with the deep geological body with relatively high temperature, the supercritical carbon dioxide has a temperature shock effect on the reservoir rock mass, resulting in changes in rock pore structure, primary fracture geometry, effective stress and other parameters of the fault fissure, which may cause significant changes in the physical and mechanical properties, seepage path and reservoir stability of the rock mass.

In order to quantitatively depict the multi-phase field coupling response of reservoir rock disturbed by the supercritical carbon dioxide injection, a large number of numerical simulations have been carried out, and the initial parameters of numerical simulations mostly come from indoor experimental tests. Optical fiber sensing technology has many advantages, such as light weight, small size, soft texture, bendability, low transmission loss, high temperature and high pressure resistance, corrosion resistance, anti-electromagnetic interference and so on, which has been widely used in scientific research and engineering fields. In terms of measurement for temperature and strain, optical fiber monitoring has been successfully applied to the laboratory rock mass supercritical carbon dioxide displacement test and the laboratory rock mass pseudo triaxial test, but there is no academic report on the cooperative detection of temperature and strain in the process of deformation and failure of reservoir rock mass under the true triaxial high temperature loading conditions.

### SUMMARY

The objective of the present disclosure is to provide a temperature-strain detection system and method for reservoir rock mass, which can achieve collaborative detection of reservoir rock mass temperature and strain under true triaxial high temperature loading conditions.

In order to achieve the above objectives, the present disclosure adopts the following technical solutions.

Firstly, the present disclosure provides a temperature-strain detection system for reservoir rock mass, which is applied to temperature-strain detection for reservoir rock mass under true triaxial high temperature loading conditions. The temperature-strain detection system for reservoir rock mass includes: a light source, a strain measurement module, a temperature measurement module, a sensing optical fiber, and a processing module.

The light source is respectively connected to the strain measurement module and the temperature measurement module; the strain measurement module and the temperature measurement module are both connected to the processing module; the strain measurement module and the temperature measurement module are both connected to the sensing optical fiber; the sensing optical fiber is arranged in the reservoir rock mass; the sensing optical fiber is engraved with an ultra-weak Fiber Grating (uwFBG) array, and the uwFBG array includes multiple uwFBGs.

The strain measurement module includes a first optical coupler, a main interference unit, and an auxiliary interference unit. The light source is connected to the main interference unit and the auxiliary interference unit respectively after passing through the first optical coupler; the main interference unit and the auxiliary interference unit are both connected to the processing module.

The main interference unit adopts the Mach Zehnder interference structure to obtain the strain signal of the sensing optical fiber; and the auxiliary interference unit adopts the Michelson interference structure to sample the strain signal of the sensing optical fiber at frequency points to obtain a strain reference signal.

The temperature measurement module adopts the coherent detection structure to measure the temperature signal of the sensing optical fiber and the temperature reference signal through the backscattered Rayleigh scattering signal.

The processing module is configured to obtain both the strain data and the temperature data of the reservoir rock mass based on the strain signal of the sensing optical fiber, the strain reference signal, the temperature signal of the sensing optical fiber, and the temperature reference signal.

Optionally, the temperature-strain detection system for reservoir rock mass further includes a first optical switch and a second optical switch.

The light source is connected to the first optical coupler and the temperature measurement module through the first optical switch.

The strain measurement module and the temperature measurement module are both connected to the sensing optical fiber through the second optical switch.

Optionally, the Mach Zehnder interference structure adopted in the main interference unit includes: a second optical coupler, a polarization controller, a first optical circulator, a third optical coupler, and a first photodetector.

One end of the second optical coupler is connected to the first optical coupler; the other end of the second optical coupler is respectively connected to one end of the polarization controller and the first end of the first optical circulator; the other end of the polarization controller is connected to one end of the third optical coupler; the other end of the third optical coupler is connected to one end of the first photodetector; the other end of the first photodetector is connected to the processing module; the third end of the first optical circulator is connected to one end of the third optical coupler; and the second end of the first optical circulator is connected to the second optical switch.

Optionally, the Michelson interference structure adopted in the auxiliary interference unit includes: a second optical circulator, a fourth optical coupler, a first reference optical fiber, a first Faraday rotator mirror, and a second photodetector.

The first end of the second optical circulator is connected to the first optical coupler; the second end of the second optical circulator is connected to one end of the fourth optical coupler; the other end of the fourth optical coupler is divided into two branches, wherein the optical signal of one branch enters the first Faraday rotator mirror through the first reference optical fiber, and the optical signal of the other branch enters the first Faraday rotator mirror; the third end of the second optical circulator is connected to the first end of the second photodetector; the second end of the second photodetector is connected to one end of the fourth optical coupler; and the third end of the second photodetector is connected to the processing module.

Optionally, the coherent detection structure adopted in the temperature measurement module includes: an optical isolator, a fifth optical coupler, a second reference optical fiber, a third photodetector, and a second Faraday rotator mirror.

One end of the optical isolator is connected to the first optical switch; the other end of the optical isolator is connected to one end of the fifth optical coupler; the other end of the fifth optical coupler is respectively connected to the second optical switch and the second reference optical fiber; the optical signal enters the second Faraday rotator mirror after passing through the second reference optical fiber; one end of the fifth optical coupler is also connected to one end of the third photodetector; the other end of the third photodetector is connected to the processing module; and the temperature reference signal is obtained based on the second reference optical fiber.

Optionally, the center wavelength of the ultra-weak grating in the uwFBG array is 1525 nm~1565 nm; the reflectivity of the sensing optical fiber is less than 0.1%; and the outer diameter of the sensing optical fiber is less than or equal to 250 μm.

Optionally, the coating material of the sensing optical fiber is one or more of gold, aluminum, and polyimide.

Optionally, the processing module includes a data acquisition card and an upper computer.

The data acquisition card is respectively connected to the main interference unit, the auxiliary interference unit, the temperature measurement module, and the upper computer.

Optionally, the light source is a tunable laser.

Secondly, the present disclosure provides a temperature-strain detection method for reservoir rock mass, which is implemented utilizing the temperature-strain detection system for reservoir rock mass provided above. The temperature-strain detection method for reservoir rock mass includes the following steps.

Obtaining strain signals and strain reference signals of the reservoir rock mass to be detected.

Transforming the strain signals and the strain reference signals from the frequency domain to the spatial domain by utilizing the discrete Fourier transform to obtain complex values in the spatial domain.

Determining the phase angles of the complex values in the spatial domain and generating a phase spectrum based on the phase angles.

Dividing the phase spectrum along the sensing optical fiber to obtain segmentation results, and obtaining the differential phases of each sensing optical fiber segment based on the segmentation results.

Correcting the phase spectrum by utilizing both the position and the wavelength variation of each uwFBG in the uwFBG array and based on the differential phase.

Unwrapping and smoothing the corrected phase spectrum, and obtaining the strain data of the reservoir rock mass to be detected through differentiation.

Performing fast Fourier transform on the temperature reference signal to obtain the position of each uwFBG after strain.

Selecting the position of the uwFBG by utilizing a sliding window, performing inverse fast Fourier transform on the segmented results within the sliding window, and separating both the beat signal and the spectrum at the selected position of the uwFBG from the temperature signal.

Carrying out wavelength peak value tracking on each uwFBG in the measurement through a wavelength peak value tracking algorithm based on the beat signal and the spectrum to obtain a wavelength peak value tracking result.

Obtaining the temperature data of the reservoir rock mass to be detected by the coupling relationship between the position of the uwFBG and both the temperature and the strain in the sensing optical fiber.

According to the specific embodiment provided by the present disclosure, the present disclosure discloses the following technical effects.

A temperature-strain detection system and method for reservoir rock mass are provided by the present disclosure. The sensing optical fiber is sensitized by the uwFBG array, and the strain information is calculated using the phase demodulation, and temperature measurement is achieved through wavelength demodulation. In the long term operation of the temperature-strain detection system for reservoir rock mass, temperature changes induce thermal expansion and contraction of the sensing optical fiber, which in turn changes the position of the uwFBG, thereby introducing strain errors and achieving strain measurement. By utilizing the principle that the deviation in the optical path is related to the wavelength shift of the uwFBG, it is possible to obtain the temperature distribution or the strain distribution along the sensing optical fiber with high spatial resolution and long measurement length. This enables the collaborative detection of the reservoir rock mass temperature and strain under true triaxial high temperature loading conditions.

### BRIEF DESCRIPTION OF THE DRAWINGS

In order to more clearly illustrate the embodiments of the present disclosure or technical solutions in the related art, the accompanying drawings used in the embodiments will now be described briefly. It is obvious that the drawings in the following description are only some embodiments of the present disclosure, and that those skilled in the art can obtain other drawings from these drawings without any creative efforts.

FIG. 1 is a structure diagram of a temperature-strain detection system for reservoir rock mass provided in an embodiment of the present disclosure;

FIG. 2 is a structure diagram of a sensing optical fiber provided in an embodiment of the present disclosure;

FIG. 3 is a data processing flowchart of a temperature-strain detection system for reservoir rock mass provided in an embodiment of the present disclosure;

FIG. 4 is a flow diagram of a temperature-strain detection method for reservoir rock mass provided in an embodiment of the present disclosure; and

FIG. 5 is structure diagram of computer equipment provided in an embodiment of the present disclosure.

### ANNOTATIONS ON THE ACCOMPANYING DRAWINGS

1—light source, 2—first optical switch, 3—strain measurement module, 31—first optical coupler, 32—auxiliary interference unit, 321—second optical circulator, 322—fourth optical coupler, 323—first reference optical fiber, 324—first Faraday rotator mirror, 325—second photodetector, 33—main interference unit, 331—second optical coupler, 332—polarization controller, 333—first optical circulator, 334—third optical coupler, 335—first photodetector, 4—temperature measurement module, 41—optical isolator, 42—fifth optical coupler, 43—second reference optical fiber, 44—second Faraday rotator mirror, 45—third photodetector, 5—second optical switch, 6—processing module, 61—data acquisition card, 62—upper computer, 7—sensing optical fiber, 71—fiber core, 72—cladding, 73—gold-plated coating, 74—ultra-weak Fiber Grating (uwFBG).

### DETAILED DESCRIPTION OF THE EMBODIMENTS

In the following, the technical solutions in the embodiments of the present disclosure will be clearly and completely described in conjunction with the accompanying drawings in the embodiments of the present disclosure. Obviously, the described embodiments are only a part of the embodiments of the present disclosure, but not all the embodiments thereof. Based on the embodiments of the present disclosure, all other embodiments obtained by those skilled in the art without any creative efforts shall fall within the scope of the present disclosure.

In order to make the above objectives, features, and advantages of the present disclosure more obvious and understandable, the following will provide further detailed explanations of the present disclosure in conjunction with the accompanying drawings and specific embodiments.

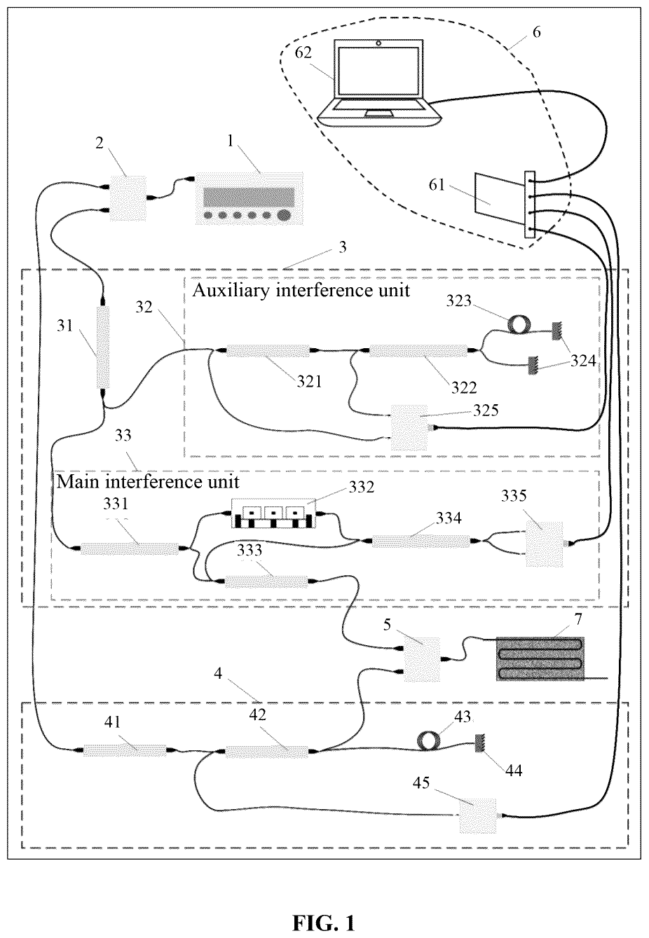

The present embodiment provides a temperature-strain detection system for reservoir rock mass under true triaxial high temperature loading conditions, as shown in FIG. 1. The temperature-strain detection system for reservoir rock mass includes: a light source 1, a strain measurement module 3, a temperature measurement module 4, a sensing optical fiber 7, and a processing module 6.

The light source 1 is respectively connected to the strain measurement module 3 and the temperature measurement module 4. The strain measurement module 3 and the temperature measurement module 4 are both connected to the processing module 6. The strain measurement module 3 and the temperature measurement module 4 are both connected to the sensing optical fiber 7. The sensing optical fiber 7 is arranged in the reservoir rock mass. The sensing optical fiber 7 is engraved with an ultra-weak Fiber Grating (uwFBG) array. The uwFBG array includes multiple uwFBGs 74. Wherein, the uwFBG 74 is the abbreviation for ultra-weak optical fiber grating proposed by Wang Anbo's research group at Virginia Tech in 2011. Weak grating is formed by regularly engraving an optical fiber grating on the fiber core, and the reflectivity of a single grate is lower than 1% or even lower. The present disclosure applies an uwFBG array to distributed optical fibers, which can effectively improve the optical signal-to-noise ratio (20 dB) and ultimately achieve accurate measurement of temperature and strain signals. In addition, gold-plated optical fibers can theoretically achieve a temperature resistance of 500 degrees centigrade, meeting the basic environmental requirements of the project.

The strain measurement module 3 includes a first optical coupler 31, a main interference unit 33, and an auxiliary interference unit 32. The light source 1 is connected to the main interference unit 33 and the auxiliary interference unit 32 respectively after passing through the first optical coupler 31. The main interference unit 33 and the auxiliary interference unit 32 are both connected to the processing module 6.

The main interference unit 33 adopts the Mach Zehnder interference structure to obtain the strain signal of the sensing optical fiber 7 to complete the measurement of the signal of the sensing optical fiber 7. The auxiliary interference unit 32 adopts the Michelson interference structure to sample the strain signal of the sensing optical fiber 7 at frequency points to obtain a strain reference signal.

The temperature measurement module 4 adopts the coherent detection structure to measure the temperature signal of the sensing optical fiber 7 and the temperature reference signal through the backscattered Rayleigh scattering signal, in order to achieve temperature measurement.

The processing module 6 is configured to obtain both the strain data and the temperature data of the reservoir rock mass based on the strain signal of the sensing optical fiber 7, the strain reference signal, the temperature signal of the sensing optical fiber 7, and the temperature reference signal.

Based on the above description, the temperature-strain detection system for reservoir rock mass provided in the present disclosure detects the Bragg wavelength changes of the uwFBG array based on the Optical Frequency Domain Reflectometry (OFDR) technology of the Mach Zehnder interference structure, and utilizes Phase-Sensitive Optical Frequency Domain Reflectometry (Φ-OFDR) technology of the Rayleigh scattering to achieve high spatial resolution and high precision measurement of temperature fields and strain fields through uwFBG sensitization.

In another exemplary embodiment of the present disclosure, in order to achieve independent measurement and joint settlement of the two optical paths, ensure stability and decoupling of temperature measurement and strain measurement, optical switches can be used to switch between different measurement modules. Based on this, as shown in FIG. 1, in this embodiment, the temperature-strain detection system for reservoir rock mass further includes a first optical switch 2 and a second optical switch 5.

The light source 1 is connected to the first optical coupler 31 and the temperature measurement module 4 through the first optical switch 2.

The strain measurement module 3 and the temperature measurement module 4 are both connected to the sensing optical fiber 7 through the second optical switch 5.

In another exemplary embodiment of the present disclosure, in order to complete the measurement of the signal of the sensing fiber optical fiber 7 and alleviate the polarization fading on the measurement arm, in this embodiment, as shown in FIG. 1, the Mach Zehnder interference structure adopted in the main interference unit 33 includes: a second optical coupler 331, a polarization controller 332, a first optical circulator 333, a third optical coupler 334, and a first photodetector 335. Wherein, the introduction of polarization controller 332 can alleviate polarization fading on the measurement arm.

One end of the second optical coupler 331 is connected to the first optical coupler 31. The other end of the second optical coupler 331 is respectively connected to one end of the polarization controller 332 and the first end of the first optical circulator 333. The other end of the polarization controller 332 is connected to one end of the third optical coupler 334. The other end of the third optical coupler 334 is connected to one end of the first photodetector 335. The other end of the first photodetector 335 is connected to the processing module 6. The third end of the first optical circulator 333 is connected to one end of the third optical coupler 334. The second end of the first optical circulator 333 is connected to the second optical switch 5.

In another exemplary embodiment of the present disclosure, in order to accurately sample the main interference signal (i.e., the signal measured by the main interference unit 33) at frequency points, in this embodiment, as shown in FIG. 1, the Michelson interference structure adopted in the auxiliary interference unit 32 includes: a second optical circulator 321, a fourth optical coupler 322, a first reference optical fiber 323, a first Faraday rotator mirror 324 and a second photodetector 325.

The first end of the second optical circulator 321 is connected to the first optical coupler 31. The second end of the second optical circulator 321 is connected to one end of the fourth optical coupler 322. The other end of the fourth optical coupler 322 is divided into two branches, wherein the optical signal of one branch enters the first Faraday rotator mirror 324 through the first reference optical fiber 323, and the optical signal of the other branch enters the first Faraday rotator mirror 324. The third end of the second optical circulator 321 is connected to the first end of the second photodetector 325. The second end of the second photodetector 325 is connected to one end of the fourth optical coupler 322. The third end of the second photodetector 325 is connected to the processing module 6.

Based on the structure of the auxiliary interference unit 32 given above, the auxiliary interference unit 32 can be matched with the main interference unit 33 through the first reference optical fiber 323, the Faraday rotator mirror, etc., to achieve sampling of the main interference signal at frequency points.

In another exemplary embodiment of the present disclosure, in order to achieve more accurate temperature measurement, as shown in FIG. 1, the coherent detection structure adopted in the temperature measurement module 4 includes: an optical isolator 41, a fifth optical coupler 42, a second reference optical fiber 43, a third photodetector 45, and a second Faraday rotator mirror 44.

One end of the optical isolator 41 is connected to the first optical switch 2. The other end of the optical isolator 41 is connected to one end of the fifth optical coupler 42. The other end of the fifth optical coupler 42 is respectively connected to the second optical switch 5 and the second reference optical fiber 43. The optical signal enters the second Faraday rotator mirror 44 after passing through the second reference optical fiber 43. One end of the fifth optical coupler 42 is also connected to one end of the third photodetector 45. The other end of the third photodetector 45 is connected to the processing module 6. The temperature reference signal is obtained based on the second reference optical fiber 43.

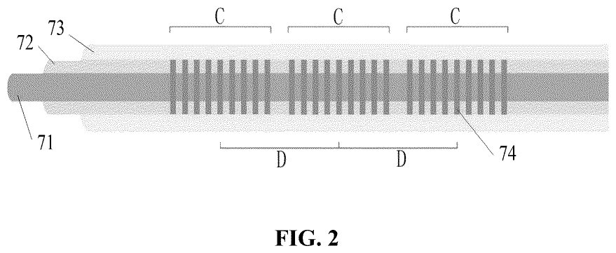

In another exemplary embodiment of the present disclosure, the high temperature resistant optical fiber is used as the sensing optical fiber 7, and the outer diameter of the optical fiber is set to be less than or equal to 250 μm to ensure long term stable operation in the environment of 500 degrees centigrade. As shown in FIG. 2, the sensing optical fiber 7 includes a fiber core 71, a cladding 72, and a gold-plated coating 73. Wherein, the material of the gold-plated coating 73 is one or more of gold, aluminum, and polyimide.

The uwFBG array is engraved between the cladding 72 and the gold-plated coating 73. The center wavelength of the uwFBG 74 in the uwFBG array can be set to 1525 nm~1565 nm, with a grating spacing of 10 mm and a grating length of 9 mm. The reflectivity is less than 0.1% to ensure the deployment of dense gratings on extremely short optical fiber lengths and achieve array sensing. However, the values of sensing optical fiber 7 and uwFBG array are not limited to the above description, and in the practical application process, the specific values can be set according to the measurement environment. In FIG. 2, D represents the grating spacing and C represents the grating length.

In another exemplary embodiment of the present disclosure, under true triaxial high temperature loading conditions, the sensing optical fiber 7 can be provided in a serpentine shape on the surface of the reservoir rock mass, with one end of the optical fiber introduced from the pressure block and distributed between the pressure block and the reservoir rock mass, and the other end led out from the pressure block and finally connected to the processing module 6. The surface of the pressure block is provided with the snake-shaped groove, and the surface of the reservoir rock mass copies the position of the snake-shaped groove for placing the sensing optical fiber 7, so that the sensing optical fiber 7 is prevented from being damaged by rigid loading stress concentration, and the detection performance and the monitoring performance of the sensing optical fiber 7 are prevented from being influenced. The inner side of the end part of the sensing optical fiber 7 channel in the pressure block, which is close to the reservoir rock mass part, is provided with a round chamfer to ensure that the sensing optical fiber 7 is not damaged when passing through the end part of the optical fiber channel of the pressure block.

Based on the above description, in practical application process, the following should be noted when deploying optical fibers.
(1) Engraved grooves on the surface of the load bearing block to avoid direct lateral pressure on the optical fiber.
(2) The bending of optical fibers can affect signal transmission, especially for weak signals with backscattering, the requirements are more stringent. So there is a requirement for the minimum bending radius when laying optical fibers. In the present disclosure, the bending resistant low loss optical fiber can be selected according to the actual situation so as to reduce the layout difficulty.
(3) Design and install the penetrators that connect the internal optical fiber and the external optical fiber to meet the requirements of high temperature and high pressure resistance.

In another exemplary embodiment of the present disclosure, the processing module 6 includes a data acquisition card 61 and an upper computer 62.

The data acquisition card 61 is respectively connected to the main interference unit 33, the auxiliary interference unit 32, the temperature measurement module 4, and the upper computer 62.

For example, the signals measured by the main interference unit 33, the auxiliary interference unit 32, and the temperature measurement module 4 are acquired by the high speed data acquisition card with four channels of 500M. The software embedded in the upper computer 62 is programmed by LabView, which completes system control, data processing and display through the time sequence control and the embedded algorithm.

In another exemplary embodiment of the present disclosure, the light source 1 is a Tunable Laser (TLS).

In another exemplary embodiment of the present disclosure, the working principle of the strain field detection and monitoring of the temperature-strain detection system for reservoir rock mass provided by the present disclosure is as follows.

The scanning laser signal (i.e., the light signal emitted by light source 1) enters the auxiliary interference unit 32 and the main interference unit 33 in a certain proportion through the first optical coupler 31. The auxiliary interference unit 32 can be a Michelson interference structure, as shown in FIG. 1, which includes the second optical circulator 321, the fourth optical coupler 322, a single-mode optical fiber (i.e., the connecting optical fiber between the fourth optical coupler 322 and the first Faraday rotator mirror), the first reference fiber 323 (i.e., a delay optical fiber), the first Faraday rotator mirror, and the second photodetector 325. Using an external clock to trigger data acquisition, the signal collected by the main interference unit 33 is sampled at a uniform optical frequency point. The main interference unit 33, also known as the Mach Zehnder interference structure, includes the second optical coupler 331, the polarization controller 332, the first circulator, the first photodetector 335, and the third optical coupler 334. Wherein, the reference arm of the main interference unit 33 is equipped with the polarization controller 332 to alleviate polarization fading on the measurement arm.

In another exemplary embodiment of the present disclosure, the working principle of the strain field detection and monitoring of the temperature-strain detection system for reservoir rock mass provided by the present disclosure is as follows.

The light source 1 is set to a certain line width and rate for full wavelength scanning. The scanning laser signal is incident on both the reference branch (including the path formed by the second reference optical fiber 43 and the second Faraday rotator mirror 44) and the measurement branch (including the path formed by the fifth optical coupler 42 and the sensing optical fiber 7) of the temperature measurement module 4 in a certain proportion through the isolator and the fifth optical coupler 42, for monitoring the temperature changes of the reservoir rock mass. The reference branch and the measurement branch form a beat frequency signal in the fifth coupler, which is then converted by the third photodetector 45. The high speed data acquisition card is used to obtain the optical signal information of each uwFBG position.

Performing Fast Fourier Transform (FFT) on the reference branch can obtain the position information of each uwFBG in the frequency domain. For specific uwFBGs, a sliding window is selected and inverse Fast Fourier Transform (IFFT) is performed to separate the beat signal and its specific spectrum at the selected uwFBG frequency (i.e. position) from the interference signal. By tracking the changes in peak wavelength of each uwFBG, distributed temperature detection and monitoring can be achieved.

In another exemplary embodiment of the present disclosure, the data processing process of the temperature-strain detection system for reservoir rock mass provided by the present disclosure is as follows.

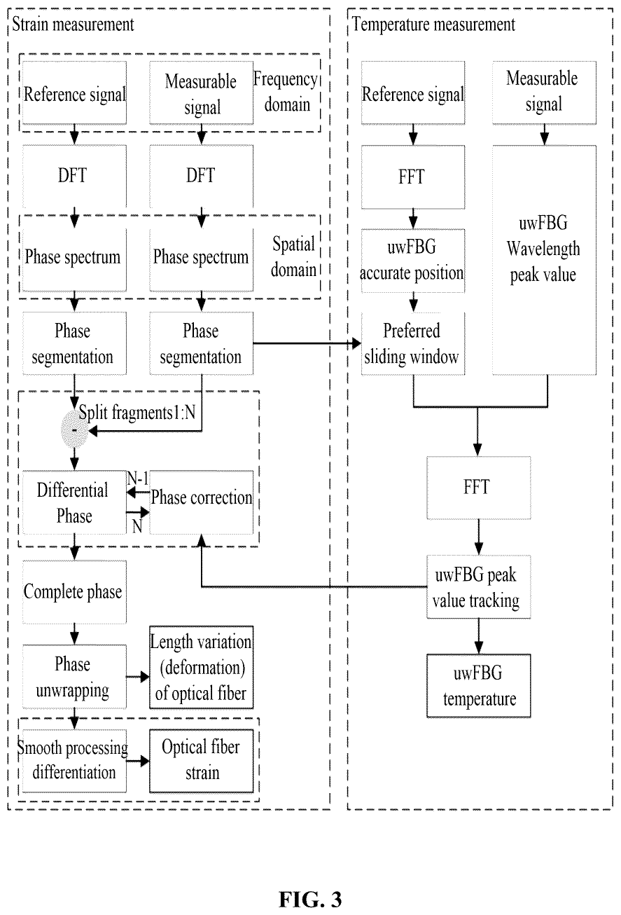

The data acquisition card 61 acquires the frequency domain signal data of the main interference unit 33 and the auxiliary interference unit 32, and the upper computer 62 performs data processing, which mainly includes the temperature measurement and the strain measurement as shown in FIG. 3. In the specific implementation process, the reference signal of the auxiliary interference unit 32 and the measurement signal of the main interference unit 33 in the frequency domain are respectively obtained by using the demodulation, the signals in the optical frequency domain (i.e., the reference signal and the measurement signal) are transformed into the spatial domain by Discrete Fourier Transform (DFT), and the phase spectrum is obtained by calculating the phase angle of the complex values in the spatial domain. Dividing the phase spectrum of the signal into multiple sections (namely performing phase segmentation) along the optical fiber, calculating the differential phase of each section through the reference phase spectrum and the measured phase spectrum of the same section, performing phase correction on the differential phase of each section to obtain a complete phase, and then performing phase unwrapping on the complete phase to obtain the length change of the optical fiber. The fiber strain can be obtained by further smoothing the complete phase after phase unwrapping.

Based on the above description, the process of strain measurement includes the following steps.
Step 1: Obtain the spatial phase spectrum. The obtained signal in the frequency domain is transformed into the spatial domain through the DFT, and the phase spectrum is obtained by calculating the phase angle of the complex values in the spatial domain.
Step 2: Segment the space and perform phase correction. The phase spectrum obtained in step 1 is divided into multiple segments along the optical fiber, and the differential phase of each segment is calculated based on the reference phase spectrum and the measured phase spectrum of the same segment.
Step 3: Phase correction. The position and the wavelength changes of each uwFBG in the uwFBG array are utilized to achieve phase correction.
Step 4: Phase unwrapping and smoothing processing. Unwrapping and smoothing the differential phase of each segment corrected in step 3 and the total differential phase, and obtaining strain data through differentiation. In this step, the obtained complete phase may be unwrapped and smoothed, and the strain data is be obtained by differentiation.

The process of temperature measurement includes:
Step 1: Determine the accurate position of the uwFBG. By performing FFT on the signal of the reference branch, the specific position of each uwFBG 74 (after strain) in the frequency domain can be obtained.
Step 2: Determine the specific spectrum of the uwFBG. Based on the segmented results in the strain measurement, a sliding window is selected and IFFT is performed to separate the beat signal and its specific spectrum at the selected uwFBG frequency from the interference signal.
Step 3: Peak tracking and temperature calculation. By using wavelength peak tracking algorithm, wavelength peak tracking is performed on each uwFBG in the measurement. By coupling the position of the uwFBG with the temperature and the strain in the optical fiber, temperature information of the environment in which the optical fiber is located is obtained.

The system provided in the present disclosure detects the Bragg wavelength changes of the uwFBG array based on the OFDR of the Mach Zehnder interferometer structure, and utilizes the Φ-OFDR of the Rayleigh scattering to achieve high spatial resolution and high precision measurement of temperature fields and strain fields through uwFBG sensitization.

Furthermore, in order to overcome the challenge of collaborative detection of the temperature field and the strain field, the present disclosure provides a key technology based on a combination of temperature in-situ calibration and position deviation compensation algorithms, achieving millimeter level spatial resolution of the strain and the temperature in uwFBG array. The sensing optical fiber is sensitized by the uwFBG array, and the strain information is calculated using the phase demodulation, and temperature measurement is achieved through wavelength demodulation. In the long term operation of the system, temperature changes induce thermal expansion and contraction of the sensing optical fiber, which in turn changes the position of the uwFBG, thereby introducing strain errors. Select a single uwFBG at the beginning/end of the uwFBG array as the temperature calibration optical grating to determine the initial position deviation and/or the cumulative position deviation. The correlation peak is used as the characteristic peak, the deviation in the optical path can be correlated with the wavelength shift, the quadratic term and the dispersion are ignored in the scanning process covering the whole uwFBG array, and the position cumulative deviation in the optical path is described by the continuous integration method. With the cumulative deviation, the first measurement spectrum of the uwFBG is modified in turn to rematch its reference and recover the cross correlation. According to the recurrence relation, the temperature distribution or the strain distribution along the optical fiber can be obtained with higher spatial resolution and longer measurement length.

Based on the same inventive concept, the embodiments of the present disclosure also provide a temperature-strain detection method for reservoir rock mass implemented based on the temperature-strain detection system for reservoir rock mass provided above. The implementation solution provided by this method is similar to the implementation solution described in the above system. Therefore, the specific limitations of one or more embodiments of the temperature-strain detection method for reservoir rock mass provided below can be referred to the limitations of the temperature-strain detection system for reservoir rock mass mentioned above, which will not be repeated here.

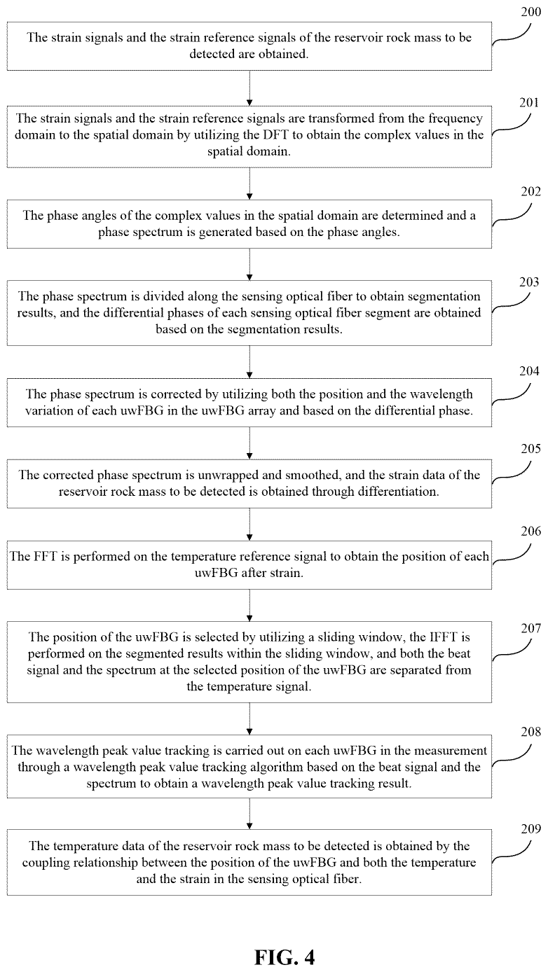

In an exemplary embodiment, as shown in FIG. 4, the temperature-strain detection method for reservoir rock mass is provided, including the following steps.
Step 200: the strain signals and the strain reference signals of the reservoir rock mass to be detected are obtained.
Step 201: the strain signals and the strain reference signals are transformed from the frequency domain to the spatial domain by utilizing the DFT to obtain the complex values in the spatial domain.
Step 202: the phase angles of the complex values in the spatial domain are determined and a phase spectrum is generated based on the phase angles.
Step 203: the phase spectrum is divided along the sensing optical fiber to obtain segmentation results, and the differential phases of each sensing optical fiber segment are obtained based on the segmentation results.
Step 204: the phase spectrum is corrected by utilizing both the position and the wavelength variation of each uwFBG in the uwFBG array and based on the differential phase.
Step 205: the corrected phase spectrum is unwrapped and smoothed, and the strain data of the reservoir rock mass to be detected is obtained through differentiation.
Step 206: the FFT is performed on the temperature reference signal to obtain the position of each uwFBG after strain.
Step 207: the position of the uwFBG is selected by utilizing a sliding window, the IFFT is performed on the segmented results within the sliding window, and both the beat signal and the spectrum at the selected position of the uwFBG are separated from the temperature signal.
Step 208: the wavelength peak value tracking is carried out on each uwFBG in the measurement through a wavelength peak value tracking algorithm based on the beat signal and the spectrum to obtain a wavelength peak value tracking result.
Step 209: the temperature data of the reservoir rock mass to be detected is obtained by the coupling relationship between the position of the uwFBG and both the temperature and the strain in the sensing optical fiber.

In addition, based on the above description, the reflective measurement method is utilized by the optical fiber of the present disclosure, which measuring by leading out both the head and tail ends. If there is an abnormality in a certain position of the optical fiber, for example, if the optical fiber breaks into two sections, either end can be used for measurement to ensure the integrity of the optical fiber sensing information.

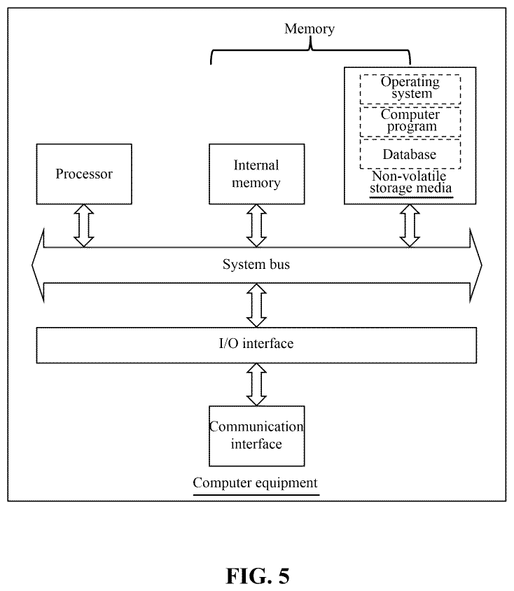

In an exemplary embodiment, a computer equipment is provided, which can be a server or a terminal, and its internal structure diagram can be shown in FIG. 5. The computer equipment includes a processor, a memory, an Input/Output interface (I/O), and a communication interface. Wherein, the processor, the memory, and the input/output interface are connected through the system bus, and the communication interface is connected to the system bus through the I/O interface. Wherein, the processor of the computer equipment is used to provide computing and control capabilities. The memory of the computer equipment includes a non-volatile storage medium and an internal memory. This non-volatile storage medium stores operating systems, computer programs, and databases. The internal memory provides an environment for the operation of operating systems and computer programs in non-volatile storage media. The database of the computer equipment is used to store temperature-strain detection data of the reservoir rock mass. The I/O interface of the computer equipment is used for exchanging information between the processor and the external equipment. The communication interface of the computer equipment is used to communicate with the external terminals through a network connection. The computer program is executed by the processor to implement a temperature-strain detection method for the reservoir rock mass.

Those of skill in the art can understand that the structure shown in FIG. 5 is only a block diagram of a part of the structure related to the present disclosure, and does not constitute a limitation on the computer equipment to which the present disclosure is applied. The specific computer equipment may include more or fewer components than shown in the figure, or combine certain components, or have different component arrangements. In an exemplary embodiment, a computer equipment is provided, including a memory and a processor, wherein the memory stores a computer program, and the processor executes the computer program to implement the steps of the above method embodiments.

In an exemplary embodiment, a computer-readable storage medium is provided which stores a computer program, the steps in the above method embodiments are implemented if the computer program is executed by the processor.

In an exemplary embodiment, a computer program product is provided, including a computer program, the steps in the above method embodiments are implemented if the computer program is executed by the processor.

It should be noted that the user information (including but not limited to user equipment information, user personal information, etc.) and data (including but not limited to data used for analysis, stored data, displayed data, etc.) involved in the present disclosure are all authorized by the user or fully authorized by all parties, and the collection, the use, and the processing of the relevant data must comply with relevant regulations.

Those of ordinary skill in the art can understand that implementing all or part of the processes in the above embodiments can be accomplished by instructing relevant hardware through a computer program. The computer program can be stored in a non-volatile computer-readable storage medium, and if executed, it can include the processes of the embodiments of the above methods. Wherein, any reference to the memory, the database, or other media used in the embodiments provided in the present disclosure may include at least one of the non-volatile memory and the volatile memory. The non-volatile memory can include a Read-Only Memory (ROM), a magnetic tape, a floppy disk, a flash memory, an optical memory, a high-density embedded non-volatile memory, a Resistive Random Access Memory (ReRAM), a Magnetoresistive Random Access Memory (MRAM), a Ferroelectric Random Access Memory (FRAM), a Phase Change Memory (PCM), a graphene memory, etc. The volatile memory can include a Random Access Memory (RAM) or an external cache memory, etc. As an illustration and not a limitation, RAM can take various forms, such as a Static Random Access Memory (SRAM) or a Dynamic Random Access Memory (DRAM).

The databases involved in the various embodiments provided in the present disclosure may include at least one of relational databases and non-relational databases. Non-relational databases may include distributed databases based on blockchain, but are not limited to these. The processors involved in the various embodiments provided in the present disclosure may be general-purpose processors, central processing units, graphics processors, digital signal processors, programmable logic units, quantum computing based data processing logic units, etc., but are not limited to these.

The various technical features of the above embodiments can be combined arbitrarily. In order to make the description concise, not all possible combinations of the various technical features in the above embodiments have been described. However, as long as there is no contradiction in the combination of these technical features, they should be considered within the scope of the present specification.

The present disclosure uses specific examples to explain the principles and implementation methods, and the above examples are only used to help understand the method and the core idea of the present disclosure. Meanwhile, for those of ordinary skill in the art, there may be changes in the specific implementation methods and application scope based on the ideas of the present disclosure. In summary, the content of the present specification should not be construed as limiting the present disclosure.

What is claimed is:

1. A temperature-strain detection system for reservoir rock mass, which is applied to temperature-strain detection for reservoir rock mass under true triaxial high temperature loading conditions; the temperature-strain detection system for reservoir rock mass comprises: a light source, a strain measurement module, a temperature measurement module, a sensing optical fiber, a processing module, a first optical switch and a second optical switch;
the light source is respectively connected to the strain measurement module and the temperature measurement module; the strain measurement module and the temperature measurement module are both connected to the processing module; the strain measurement module and the temperature measurement module are both connected to the sensing optical fiber; the sensing optical fiber is arranged in reservoir rock mass; the sensing optical fiber is engraved with an ultra-weak Fiber Grating (uwFBG) array, and the uwFBG array comprises multiple uwFBGs; select a single uwFBG at a beginning/an end of the uwFBG array as a temperature calibration optical grating to determine an initial position deviation and/or a cumulative position deviation;
the strain measurement module comprises a first optical coupler, a main interference unit, and an auxiliary interference unit; the light source is respectively connected to the main interference unit and the auxiliary interference unit after passing through the first optical coupler; the main interference unit and the auxiliary interference unit are both connected to the processing module;
the main interference unit adopts a Mach Zehnder interference structure to obtain a strain signal of the sensing optical fiber; and the auxiliary interference unit adopts a Michelson interference structure to sample the strain signal of the sensing optical fiber at frequency points to obtain a strain reference signal;
the temperature measurement module adopts a coherent detection structure to measure a temperature signal of the sensing optical fiber and a temperature reference signal through a backscattered Rayleigh scattering signal;
the processing module is configured to obtain both strain data and the temperature data of the reservoir rock mass based on the strain signal of the sensing optical fiber, the strain reference signal, the temperature signal of the sensing optical fiber, and the temperature reference signal;
the light source is connected to the first optical coupler and the temperature measurement module through the first optical switch;
the strain measurement module and the temperature measurement module are both connected to the sensing optical fiber through the second optical switch;
the Mach Zehnder interference structure adopted in the main interference unit comprises: a second optical coupler, a polarization controller, a first optical circulator, a third optical coupler, and a first photodetector;
one end of the second optical coupler is connected to the first optical coupler; an other end of the second optical coupler is respectively connected to one end of the polarization controller and a first end of the first optical circulator; an other end of the polarization controller is connected to one end of the third optical coupler; an other end of the third optical coupler is connected to one end of the first photodetector; an other end of the first photodetector is connected to the processing module; a third end of the first optical circulator is connected to one end of the third optical coupler; and a second end of the first optical circulator is connected to the second optical switch.

2. The temperature-strain detection system for reservoir rock mass according to claim 1, wherein the Michelson interference structure adopted in the auxiliary interference unit comprises: a second optical circulator, a fourth optical coupler, a first reference optical fiber, a first Faraday rotator mirror, and a second photodetector;
a first end of the second optical circulator is connected to the first optical coupler; a second end of the second optical circulator is connected to one end of the fourth optical coupler; an other end of the fourth optical coupler is divided into two branches, wherein an optical signal of one branch enters the first Faraday rotator mirror through the first reference optical fiber, and an optical signal of an other branch enters the first Faraday rotator mirror; a third end of the second optical circulator is connected to a first end of the second photodetector; a second end of the second photodetector is connected to one end of the fourth optical coupler; and a third end of the second photodetector is connected to the processing module.

3. The temperature-strain detection system for reservoir rock mass according to claim 1, wherein the coherent detection structure adopted in the temperature measurement module comprises: an optical isolator, a fifth optical coupler, a second reference optical fiber, a third photodetector, and a second Faraday rotator mirror;
one end of the optical isolator is connected to the first optical switch; an other end of the optical isolator is connected to one end of the fifth optical coupler; an other end of the fifth optical coupler is respectively connected to the second optical switch and the second reference optical fiber; an optical signal enters the second Faraday rotator mirror after passing through the second reference optical fiber; one end of the fifth optical coupler is also connected to one end of the third photodetector; an other end of the third photodetector is connected to the processing module; and the temperature reference signal is obtained based on the second reference optical fiber.

4. The temperature-strain detection system for reservoir rock mass according to claim 1, wherein a center wavelength of the uwFBG in the uwFBG array is 1525 nm~1565 nm; reflectivity of the sensing optical fiber is less than 0.1%; and an outer diameter of the sensing optical fiber is less than or equal to 250 μm.

5. The temperature-strain detection system for reservoir rock mass according to claim 1, wherein a coating material of the sensing optical fiber is one or more of gold, aluminum, and polyimide.

6. The temperature-strain detection system for reservoir rock mass according to claim 1, wherein the processing module comprises: a data acquisition card and an upper computer;
the data acquisition card is respectively connected to the main interference unit, the auxiliary interference unit, the temperature measurement module, and the upper computer.

7. The temperature-strain detection system for reservoir rock mass according to claim 1, wherein the light source is a tunable laser.

8. A temperature-strain detection method for reservoir rock mass, which is implemented utilizing the temperature-strain detection system for reservoir rock mass as claimed in claim 1; the temperature-strain detection method for reservoir rock mass comprises:
obtaining strain signals and strain reference signals of reservoir rock mass to be detected;
transforming the strain signals and the strain reference signals from a frequency domain to a spatial domain by utilizing discrete Fourier transform to obtain complex values in the spatial domain;
determining phase angles of the complex values in the spatial domain and generating a phase spectrum based on the phase angles;
dividing the phase spectrum along the sensing optical fiber to obtain segmentation results, and obtaining differential phases of each sensing optical fiber segment based on the segmentation results;
correcting the phase spectrum by utilizing both a position and a wavelength variation of each uwFBG in a uwFBG array and based on the differential phase;
unwrapping and smoothing the corrected phase spectrum, and obtaining strain data of the reservoir rock mass to be detected through differentiation;
performing fast Fourier transform on the temperature reference signal to obtain a position of each uwFBG after strain;
selecting a position of the uwFBG by utilizing a sliding window, performing inverse fast Fourier transform on the segmented results within the sliding window, and separating both a beat signal and a spectrum at the selected position of the uwFBG from a temperature signal;
carrying out wavelength peak value tracking on each uwFBG in a measurement through a wavelength peak value tracking algorithm based on the beat signal and the spectrum to obtain a wavelength peak value tracking result; and
obtaining temperature data of the reservoir rock mass to be detected by the coupling relationship between a position of the uwFBG and both temperature and strain in the sensing optical fiber;
the temperature-strain detection system for reservoir rock mass comprises: a light source, a strain measurement module, a temperature measurement module, a sensing optical fiber, a processing module, a first optical switch and a second optical switch;
the light source is respectively connected to the strain measurement module and the temperature measurement module; the strain measurement module and the temperature measurement module are both connected to the processing module; the strain measurement module and the temperature measurement module are both connected to the sensing optical fiber; the sensing optical fiber is arranged in reservoir rock mass; the sensing optical fiber is engraved with a uwFBG array, and the uwFBG array comprises multiple uwFBGs; select a single uwFBG at a beginning/an end of the uwFBG array as a temperature calibration optical grating to determine an initial position deviation and/or a cumulative position deviation;
the strain measurement module comprises a first optical coupler, a main interference unit, and an auxiliary interference unit; the light source is respectively connected to the main interference unit and the auxiliary interference unit after passing through the first optical coupler; the main interference unit and the auxiliary interference unit are both connected to the processing module;
the main interference unit adopts a Mach Zehnder interference structure to obtain a strain signal of the sensing optical fiber; and the auxiliary interference unit adopts a Michelson interference structure to sample the strain signal of the sensing optical fiber at frequency points to obtain a strain reference signal;
the temperature measurement module adopts a coherent detection structure to measure a temperature signal of the sensing optical fiber and a temperature reference signal through a backscattered Rayleigh scattering signal;
the processing module is configured to obtain both strain data and the temperature data of the reservoir rock mass based on the strain signal of the sensing optical fiber, the strain reference signal, the temperature signal of the sensing optical fiber, and the temperature reference signal;
the light source is connected to the first optical coupler and the temperature measurement module through the first optical switch;
the strain measurement module and the temperature measurement module are both connected to the sensing optical fiber through the second optical switch;
the Mach Zehnder interference structure adopted in the main interference unit comprises: a second optical coupler, a polarization controller, a first optical circulator, a third optical coupler, and a first photodetector;
one end of the second optical coupler is connected to the first optical coupler; an other end of the second optical coupler is respectively connected to one end of the polarization controller and a first end of the first optical circulator; an other end of the polarization controller is connected to one end of the third optical coupler; an other end of the third optical coupler is connected to one end of the first photodetector; an other end of the first photodetector is connected to the processing module; a third end of the first optical circulator is connected to one end of the third optical coupler; and a second end of the first optical circulator is connected to the second optical switch.

9. The temperature-strain detection method for reservoir rock mass according to claim 8, wherein the Michelson interference structure adopted in the auxiliary interference unit comprises: a second optical circulator, a fourth optical coupler, a first reference optical fiber, a first Faraday rotator mirror, and a second photodetector;
a first end of the second optical circulator is connected to the first optical coupler; a second end of the second optical circulator is connected to one end of the fourth optical coupler; an other end of the fourth optical coupler is divided into two branches, wherein an optical signal of one branch enters the first Faraday rotator mirror through the first reference optical fiber, and an optical signal of an other branch enters the first Faraday rotator mirror; a third end of the second optical circulator is connected to a first end of the second photodetector; a second end of the second photodetector is connected to one end of the fourth optical coupler; and a third end of the second photodetector is connected to the processing module.

10. The temperature-strain detection method for reservoir rock mass according to claim 8, wherein the coherent detection structure adopted in the temperature measurement module comprises: an optical isolator, a fifth optical coupler, a second reference optical fiber, a third photodetector, and a second Faraday rotator mirror;
one end of the optical isolator is connected to the first optical switch; an other end of the optical isolator is connected to one end of the fifth optical coupler; an other end of the fifth optical coupler is respectively connected to the second optical switch and the second reference optical fiber; an optical signal enters the second Faraday rotator mirror after passing through the second reference optical fiber; one end of the fifth optical coupler is also connected to one end of the third photodetector; an other end of the third photodetector is connected to the processing module; and the temperature reference signal is obtained based on the second reference optical fiber.

11. The temperature-strain detection method for reservoir rock mass according to claim 8, wherein a center wavelength of the uwFBG in the uwFBG array is 1525 nm~1565 nm; reflectivity of the sensing optical fiber is less than 0.1%; and an outer diameter of the sensing optical fiber is less than or equal to 250 μm.

12. The temperature-strain detection method for reservoir rock mass according to claim 8, wherein a coating material of the sensing optical fiber is one or more of gold, aluminum, and polyimide.

13. The temperature-strain detection method for reservoir rock mass according to claim 8, wherein the processing module comprises: a data acquisition card and an upper computer;
the data acquisition card is respectively connected to the main interference unit, the auxiliary interference unit, the temperature measurement module, and the upper computer.

14. The temperature-strain detection method for reservoir rock mass according to claim 8, wherein the light source is a tunable laser.
